(19) United States
(12) Patent Application Publication
(10) Pub. No.: US 2006/0055161 A1
(43) Pub. Date: Mar. 16, 2006

(54) Wheel cover and storage device for a spare tire and method therefor

(76) Inventors: Joseph M. Bartorelli, Scottsdale, AZ (US); Kevin J. Wall, Tempe, AZ (US)

Correspondence Address: WEISS & MOY PC, 4204 NORTH BROWN AVENUE, SCOTTSDALE, AZ, 85251, US

(21) Appl. No.: 10/942,403

(22) Filed: Sep. 16, 2004

(51) Int. Cl. B60B 11/10

(52) U.S. Cl. 280/767

(57) ABSTRACT

A wheel cover has a front panel. A top panel is coupled to the front panel. The top panel is semi-circular in shape and is used to cover a top portion of the wheel. The top panel has a flap member which extends down from the top panel and covers part of a rear side of the wheel. An attachment device is coupled to the top panel and the front panel. The attachment device is used to couple the wheel cover to the wheel so that the wheel cover will not fall off when driving.

### BACKGROUND OF THE INVENTION

1. Field of the Invention

This invention relates to wheel covers and, more specifically, to a wheel cover which would be attached to a spare tire to protect the spare tire from the elements and which would further function as a storage device for holding different items.

2. Description of the Prior Art

The use of a vehicle wheel cover is well known in the prior art. One well known type of wheel cover is a flexible tire cover for a spare tire. The flexible wheel cover is placed over a spare tire which is mounted on the rear of a vehicle in an exposed manner. These types of wheel covers are used to protect the spare wheels from the elements. To add aesthetic value to these types of wheel covers, readily visible personalized messages or artwork are sometimes applied thereto.

The main problem with current flexible wheel covers is their lack of functionality. Other than protecting the spare tire from the elements, the flexible wheel cover has no other functionality. One cannot use current flexible wheel covers for any other purpose besides covering a spare tire.

Therefore, there is a need to provide an improved flexible wheel cover. The improved flexible wheel cover must overcome the problems associated with prior art flexible wheel covers. The improved flexible wheel cover must have more functionality than prior art flexible wheel covers. The improved flexible wheel cover must be able to hold and store a plurality of different items.

### SUMMARY OF THE INVENTION

In accordance with one embodiment of the present invention, it is an object of the present invention to provide an improved flexible wheel cover.

It is another object of the present invention to provide an improved flexible wheel cover that overcomes the problems associated with prior art flexible wheel covers.

It is still another object of the present invention to provide an improved flexible wheel cover that has more functionality than prior art flexible wheel covers.

It is still another object of the present invention to provide an improved flexible wheel cover that is able to hold and store a plurality of different items.

### BRIEF DESCRIPTION OF THE EMBODIMENTS

In accordance with one embodiment of the present invention a wheel cover is disclosed. The wheel cover has a front panel. A top panel is coupled to the front panel. The top panel is semi-circular in shape and covers a top portion of the wheel. The top panel has a flap member which extends down from the top panel and covers part of a rear side of the wheel. An attachment device is coupled to the top panel and the front panel. The attachment device is used to couple the wheel cover to the wheel so that the wheel cover will not fall off when driving.

In accordance with another embodiment of the present invention a wheel cover for a spare tire is disclosed. The wheel cover has a front panel. A top panel is coupled to the front panel. The top panel is semi-circular in shape and covers a top portion of the spare tire. The top panel has a flap member which extends down from the top panel and covers part of a rear side of the spare tire. Side panels are coupled to the front panel and the top panel to further protect the spare tire. An attachment device is coupled to the top panel and the front panel. The attachment device is used to couple the wheel cover to the spare tire so that the wheel cover will not fall off when driving. At least one pocket member is coupled to the front panel for storing items. At least one strap holder is coupled to the front panel and used to hold large objects that do not fit in the pocket members. At least one side pocket member is coupled to the side panel to hold and store items.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a front view of one embodiment of the improved flexible wheel cover of the present invention.

FIG. 2 is a side view of the improved flexible wheel cover depicted in FIG. 1.

FIG. 3 is a top view of the improved flexible wheel cover depicted in FIG. 1.

FIG. 4 is a rear view of the improved flexible wheel cover depicted in FIG. 1.

FIG. 5 is an elevated perspective view of another embodiment of the improved flexible wheel cover of the present invention.

### DETAILED DESCRIPTION OF THE PREFERRED EMBODIMENT

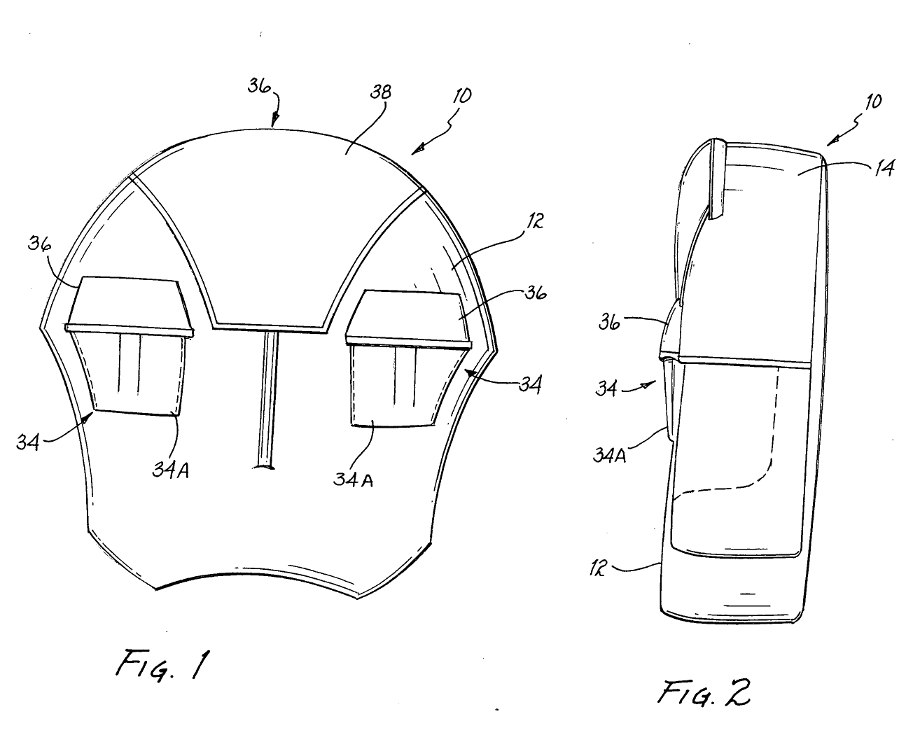

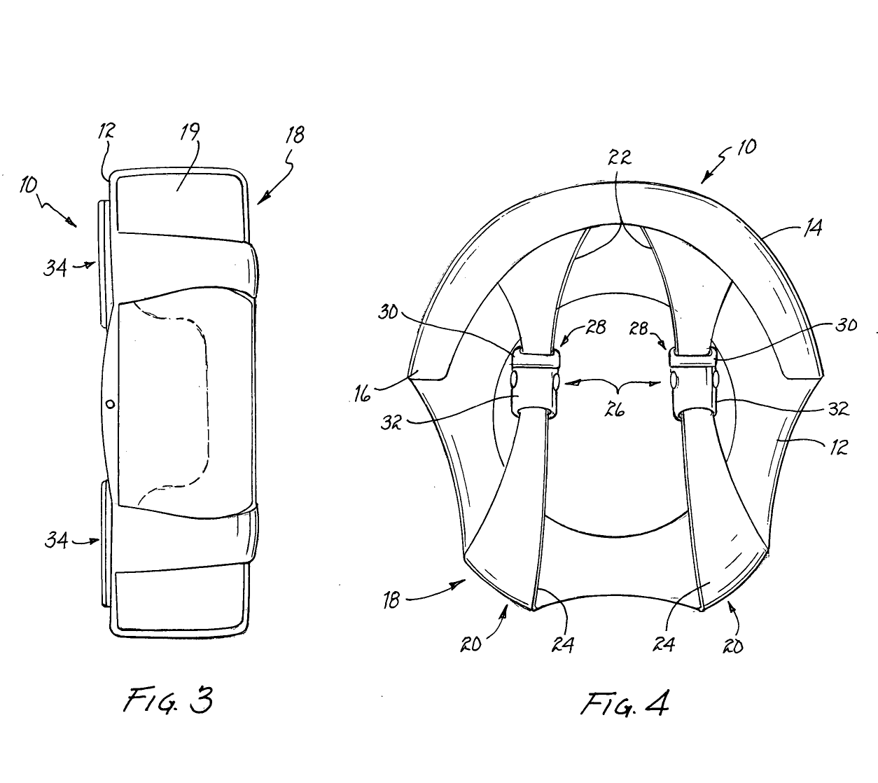

Referring to FIGS. 1-4, wherein like numerals and symbols represent like elements, an improved wheel cover 10 (hereinafter wheel cover 10) is shown. The wheel cover 10 is placed over an exposed spare tire and used to protect the spare tire from the elements. The wheel cover 10 further allows one to store items in the wheel cover 10.

The wheel cover 10 is made out of a flexible material which is placed over the spare tire. The material is generally water repellent to protect the spare tire from the elements. In general, a material like vinyl, nylon, ballistic nylon, or the like. However, the listing of the above should not be seen as to limit the scope of the present invention.

The wheel cover 10 has a front panel 12. The front panel 12 is used to cover the front of the spare tire. A top panel 14 is coupled to the front panel. The top panel 14 is semi-circular in shape so that the top panel 14 will cover the top portion of the spare tire. The top panel 14 further has a flap member 16 which extends down from the top panel 14 and covers part of the rear side of the spare tire.

An attachment device 18 is coupled to the top panel 14 and the front panel 12. The attachment device 18 is used to couple the wheel cover 10 to the spare tire so that the wheel cover 10 will not fall off when driving. The attachment device 18 is generally comprised of a pair of strap members 20. A first strap member 22 is coupled to the bottom edge portion of the flap member 16 which extends down from the top panel 14. A second strap member 24 is coupled to a bottom edge portion of the front panel 12. A coupling mechanism 26 is used to attach the first strap member 22 to the second strap member 24. The coupling mechanism 26 can be a buckle, a male/female connector, or the like. In accordance with one embodiment of the present invention, the coupling mechanism 26 is a male female connector 28. A first member 30 of the male female connector 28 is coupled to an end of the first strap member 22. A second member 32 of the male female connector 28 is coupled to an end of the second strap member 24.

A plurality of pocket members 34 are coupled to the front panel 12. The pocket members 34 are used to hold and store any item a person chooses to place inside. Each pocket member 34 is formed by having a pocket panel 34A coupled to the front panel 12. The pocket panel 34A is coupled on both side edges and a bottom edge section to the front panel 12. A top edge section is left open so that items may be placed inside the pocket member 34. A flap 36 is coupled to a top section of the pocket members 34. The flap 36 is used to cover the opening in the pocket member 34 to keep items inside the pocket members 34.

The pocket members 34 may come in varying shapes and sizes. As seen In FIG. 1, a larger pocket member 36 is placed in the upper center region of the front panel. The larger pocket member 36 is used to hold items which may not fit in the pocket members 34. A flap 38 is used to cover an opening in the larger pocket member 36.

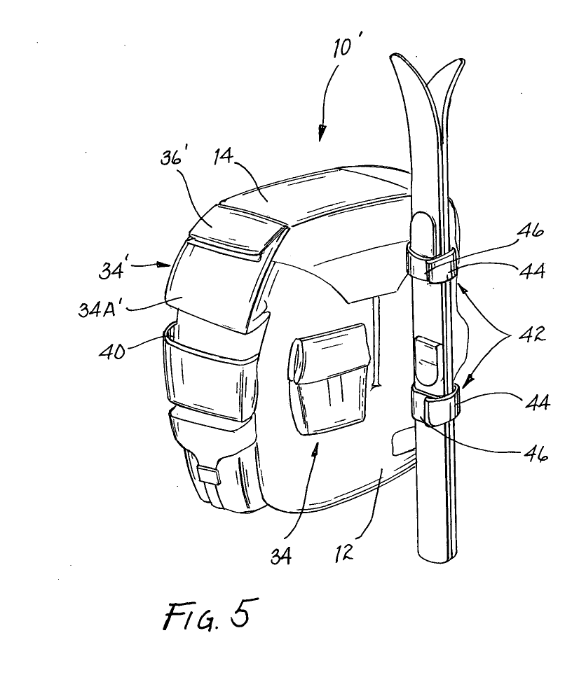

Referring now to FIG. 5, another embodiment of the wheel cover 10′ is shown. Like the previous embodiment, the wheel cover 10′ is made out of a flexible material which is placed over the spare tire. The material is generally water repellent to protect the wheel from the elements. In general, a material like vinyl, nylon, ballistic nylon, or the like. However, the listing of the above should not be seen as to limit the scope of the present invention.

The wheel cover 10′ is similar to the wheel cover 10 discussed above. The main difference is that side panels 40 are coupled to the front panel 12 and the top panel 14. The side panels 40 are coupled to each side of the front panel 12 and are used to further protect the spare tire. Attached to the side panels 40 is a plurality of side pocket members 34′. These side pocket members 34′ are the same as those coupled to the front panel 12. The side pocket members 34′ are used to hold and store any item a person chooses to place inside. Each side pocket member 34′ is formed by having a side pocket panel 34A′ coupled to the side panel 40. The side pocket panel 34A′ is coupled on both side edges and a bottom edge section to the side panel 40. A top edge section is left open so that items may be placed inside the side pocket member 34′. A flap 36′ is coupled to a top section of the side pocket members 34′. The flap 36′ is used to cover the opening in the side pocket member 34′ to keep items inside the side pocket members 34′.

The wheel cover 10′ also differs from the wheel cover 10 by including a pair of strap holders 42. The strap holders 42 are coupled to the front panel 12 and are used to hold large objects that do not fit in the pocket members 34. Each strap holder 42 comprises an elongated strap 44 having a central portion coupled to the front panel 12. Each end of the strap 44 will have coupling means 46 to coupled the ends together in order to hold an object. The coupling means can be a like a belt buckle and holes, hook and loop material, snap connectors and the like. The listing of the above should not be seen as to limit the scope of the present invention.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A wheel cover comprising:
a front panel,
a top panel coupled to the front panel, the top panel being semi-circular in shape and covers a top portion of a wheel, the top panel having a flap member which extends down from the top panel and covers part of a rear side of the wheel; and
an attachment device coupled to the top panel and the front panel, the attachment device is used to couple the wheel cover to the wheel so that the wheel cover will not fall off when driving.

2. A wheel cover in accordance with claim 1 wherein the attachment device comprises:
at least one attachment strap member, the attachment strap member comprising:
a first strap coupled to a bottom edge portion of the flap member; and
a second strap coupled to a bottom edge portion of the front panel; and
a coupling mechanism used to couple the first strap to the second strap.

3. A wheel cover in accordance with claim 1 wherein the coupling mechanism comprises a male/female connector, the male/female connector comprising:
a first member coupled to an end of the first strap; and
a second member coupled to an end of the second strap.

4. A wheel cover in accordance with claim 1 further comprising at least one pocket member coupled to the front panel for storing items.

5. A wheel cover in accordance with claim 4 wherein the pocket member comprises:
a pocket panel coupled on three sides to the front panel; and
a flap coupled to the front panel and covering an open end of the pocket panel.

6. A wheel cover in accordance with claim 1 further comprising at least one strap holder coupled to the front panel and used to hold large objects that do not fit in the pocket members.

7. A wheel cover in accordance with claim 6 wherein the strap holder comprises:
an elongated strap having a central portion coupled to the front panel; and
coupling device coupled to each end of the elongated strap for coupling each end together to secure an object.

8. A wheel cover in accordance with claim 7 wherein the coupling device is one of a belt buckle and holes, hook and loop material, or snap connectors.

9. A wheel cover in accordance with claim 1 further comprising a side panel coupled to the front panel and the top panel to further protect the spare tire.

10. A wheel cover in accordance with claim 9 further comprising at least one side pocket members coupled to the side panels to hold and store items.

11. A wheel cover in accordance with claim 10 wherein the at least one side pocket member comprises:
a side pocket panel coupled on both side edges and a bottom edge section to the side panel, a top edge section left open so that items may be placed inside the side pocket member; and
a side pocket flap coupled to a top section of the side pocket members to cover the opening in the side pocket member to keep items inside the side pocket members.

12. A wheel cover for a spare tire comprising:
a front panel,
a top panel coupled to the front panel, the top panel being semi-circular in shape and covers a top portion of the spare tire, the top panel having a flap member which extends down from the top panel and covers part of a rear side of the spare tire;
side panels coupled to the front panel and the top panel to further protect the spare tire;
an attachment device coupled to the top panel and the front panel, the attachment device is used to couple the wheel cover to the spare tire so that the wheel cover will not fall off when driving;
at least one pocket member coupled to the front panel for storing items;
at least one strap holder coupled to the front panel and used to hold large objects that do not fit in the pocket members; and
at least one side pocket member coupled to the side panel to hold and store items.

13. A wheel cover in accordance with claim 12 wherein the attachment device comprises:
at least one attachment strap member, the attachment strap member comprising:
a first strap coupled to a bottom edge portion of the flap member; and
a second strap coupled to a bottom edge portion of the front panel; and
a coupling mechanism used to couple the first strap to the second strap.

14. A wheel cover in accordance with claim 12 wherein the coupling mechanism comprises a male/female connector, the male/female connector comprising:
a first member coupled to an end of the first strap; and
a second member coupled to an end of the second strap.

15. A wheel cover in accordance with claim 12 wherein the pocket member comprises:
a pocket panel coupled on three sides to the front panel; and
a flap coupled to the front panel and covering an open end of the pocket panel.

16. A wheel cover in accordance with claim 12 wherein the strap holder comprises:
an elongated strap having a central portion coupled to the front panel; and
coupling device coupled to each end of the elongated strap for coupling each end together to secure an object.

17. A wheel cover in accordance with claim 16 wherein the coupling device is one of a belt buckle and holes, hook and loop material, or snap connectors.

18. A wheel cover in accordance with claim 12 wherein the at least one side pocket member comprises:
a side pocket panel coupled on both side edges and a bottom edge section to the side panel, a top edge section left open so that items may be placed inside the side pocket member; and
a side pocket flap coupled to a top section of the side pocket members to cover the opening in the side pocket member to keep items inside the side pocket members.
